(19) United States
(12) Patent Application Publication
(10) Pub. No.: US 2008/0148889 A1
(43) Pub. Date: Jun. 26, 2008

(54) Actuator

(76) Inventors: Andrew James Elliot, Victoria (AU); Wayne Andrew Harris, Victoria (AU)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/643,820

(22) Filed: Dec. 22, 2006

(51) Int. Cl. F16H 3/06

(52) U.S. Cl. 74/89.45

(57) ABSTRACT

An actuator for use in adjusting a device by means of a Bowden cable includes a housing and an input shaft mounted in the housing and rotatable on a first axis. The shaft has an eccentric portion centered on a second axis laterally offset from the first axis, while a gear track defined by, or fixed in relation to, the housing is concentric with the first axis. A gear is rotatable on the eccentric portion and drivingly engaged with teeth of the gear track. A pulley member rotatably mounted on the input shaft is rotatable with rotation of the gear and is adapted for securing an end of a wire of a Bowden cable. With rotation of the input shaft on the first axis, the gear is caused by the eccentric to orbit around the first axis. In so orbiting the gear is caused by its engagement with the gear track to rotate on the second axis and thereby rotate the pulley member for longitudinally advancing or retracting the wire of the Bowden cable relative to the sheath of a Bowden cable.

### BACKGROUND OF THE INVENTION

1. Field of the Invention

This invention relates to an actuator for actuating ergonomic devices such as lumbar supports employed in vehicle seats in aircraft, waterborne vehicles and land vehicles. While, it will be convenient to hereinafter disclose the invention in relation to its use to actuate lumbar supports, it is to be appreciated that the invention is not limited to that application.

2. Description of the Prior Art

It is well known to provide ergonomic devices such as lumbar supports in vehicle seats. Various different forms of adjustable lumbar supports exist, comprising a large variety of different types of lumbar supports and interconnected actuators that allow a user to adjust the configuration of the lumbar support.

The actuator used to adjust the lumbar support can be activated and controlled by one or more motors or by mechanical means such as levers and controls to set the lumbar support at a particular adjusted position. One type of mechanical actuator includes a rotatable knob which can be rotated clockwise or anticlockwise to extend or retract a Bowden cable operatively connected to a lumbar support. Movement of the Bowden cable sets the lumbar support in an adjusted position. It is desirable that the lumbar support remains stable at this adjusted position, particularly when a backdriving force is applied to the actuator, such as applied by a vehicle occupant sitting on the vehicle seat.

Some forms of actuator include a braking mechanism for braking the actuator against any applied backdriving force. The braking mechanism is typically a biasing spring which applies a resistance force to one or more driven components of the actuator to counteract the backdriving force.

However, such a braking mechanism also generally applies a resistance force which resists rotation of the knob. Therefore, to adjust the actuator, a user must apply a force which overcomes the resistance force, and also operates the actuator to perform the lumbar support adjustment. While this problem can be generally alleviated by including a gearing system between the knob and driven components within the actuator, the inclusion of the braking and gearing system tends to increase the complexity and number of parts used in the actuator, adding to production and assembly costs.

It is an object of the present invention to provide an improved actuator which overcomes or at least alleviates one or more of the foregoing disadvantages.

### SUMMARY OF THE INVENTION

According to the present invention, there is provided an actuator, suitable for use in adjusting a device by means of a Bowden cable, wherein the actuator includes:
(a) a housing;
(b) an input shaft mounted in the housing and rotatable on a first axis, the shaft having an eccentric portion centered on a second axis laterally offset from the first axis;
(c) a gear track defined by, or fixed in relation to, the housing and concentric with the first axis;
(d) a gear member rotatable on the eccentric portion of the input shaft and drivingly engaged with teeth of the gear track defined by, or fixed in relation to, the housing; and
(e) a pulley member rotatably mounted on the input shaft and rotatable with rotation of the gear member the pulley being adapted for securing an end of a wire of a Bowden cable;

wherein, with rotation of the input shaft on the first axis, the gear member is caused by the eccentric to orbit around the first axis while being caused by its engagement with the gear track to rotate on the second axis and thereby rotate the pulley member for longitudinally advancing or retracting the wire of the Bowden cable relative to the sheath of a Bowden cable.

The gear member and the pulley member may inter-fit in a manner enabling the pulley member to rotate on the first axis in response to rotation of the gear member on the second axis, while enabling the gear member to orbit with respect to the first axis relative to the pulley member. The gear member and the pulley member may inter-fit by projections on one of them locating in recesses in the other of them, with the recesses being larger than the projections thereby to allow orbiting of the gear member relative to the pulley member. Alternatively, the gear member and the pulley member may move in unison so that they each rotate on the second axis while orbiting with respect to the first axis. In that alternative the pulley member and the gear member may be secured together so as to be movable in unison, or they may be parts of an integral component such as one which is integrally formed.

The gear track preferably is formed integrally with a section of the housing. The gear member preferably is an externally toothed gear, while the gear track preferably is an internally toothed gear track formed integrally with a section of the housing, with the teeth of the gear and gear track in direct meshed engagement.

The pulley member may be of ovoid shape to define a first part adjacent to which the gear member is located and a second part which extends laterally beyond the gear member. In that case the pulley member preferably is adapted for securing an end of the wire of the Bowden cable at a location on the second part of the pulley member spaced from the first and second axes by about twice the radius of the gear member. The pulley member preferably defines a circumferential groove, which extends from said location, in which the wire can be wound or unwound, depending on the direction of rotation of the pulley member.

The input shaft may have a first end portion to which a knob or handle for rotating the shaft member can be fitted, a section adjacent to the first end portion which defines the eccentric portion and between the eccentric portion and a second end portion, a portion on which the pulley member is located. In such an arrangement, the gear member and the pulley member may move in unison so that they each rotate on the second axis while orbiting with respect to the first axis, with the portion of the input shaft on which the pulley member is located forming an eccentric continuation of the eccentric portion.

The housing preferably has two releasably connected housing parts, one of the housing parts defining a skirt in which the first end portion of the input shaft is received, and the other housing part defining a recess in which the second end portion of the input shaft is rotatable. The input shaft may have a peripheral flange between the first end portion and the eccentric portion, with the one housing part defining a seat in which the flange is located.

### BRIEF DESCRIPTION OF THE DRAWINGS

The present invention will now be described with reference to the figures of the accompanying drawings, which illustrates one particular preferred embodiment of the present invention, wherein:

FIG. 1 is a top perspective view of an actuator according to one embodiment of the invention;

FIG. 2 is a bottom perspective view of the actuator shown in FIG. 1;

FIG. 3 is an exploded view of the actuator of FIGS. 1 and 2;

FIG. 4 shows plan view of the actuator of FIG. 1;

FIG. 5 shows a sectional view of the actuator of FIG. 1, taken along line V-V of FIG. 4;

FIG. 6 shows a side elevation view of the actuator of FIG. 1;

FIGS. 7(a) and 7(b) show respective perspective views of a knob for the actuator of FIG. 1, FIG. 7(a) showing a top perspective view and FIG. 7(b) showing a bottom perspective view;

FIGS. 8(a) and 8(b) show respective perspective views of a rotatable input member of the actuator of FIG. 1, FIG. 8(a) showing a top perspective view and FIG. 8(b) showing a bottom perspective view;

FIGS. 9(a) and 9(b) show respective perspective views of a drive member of the actuator of FIG. 1, FIG. 9(a) showing a bottom perspective view and FIG. 9(b) showing a top perspective view;

FIGS. 10(a) and (10b) show respective perspective views of a driven member of the actuator of FIG. 1, FIG. 10(a) showing a bottom perspective view and FIG. 10(b) showing a top perspective view;

FIGS. 11(a) and 11(b) show respective perspective views of an upper housing part of the actuator of FIG. 1, FIG. 11(a) showing a top perspective view and FIG. 11(b) showing a bottom perspective view;

FIGS. 12(a) and 12(b) show respective perspective views of a lower housing part of the actuator of FIG. 1, FIG. 12(a) showing a perspective bottom view and FIG. 12(b) showing a top perspective view;

FIGS. 13(a) and 13(b) respectively show a top perspective view and a side elevational view of a composite member for an actuator according to a second embodiment which otherwise may be the same as the actuator of FIG. 1; and

FIG. 14 is a sectional view taken on line XIV-XIV of FIG. 13(b).

### DETAILED DESCRIPTION

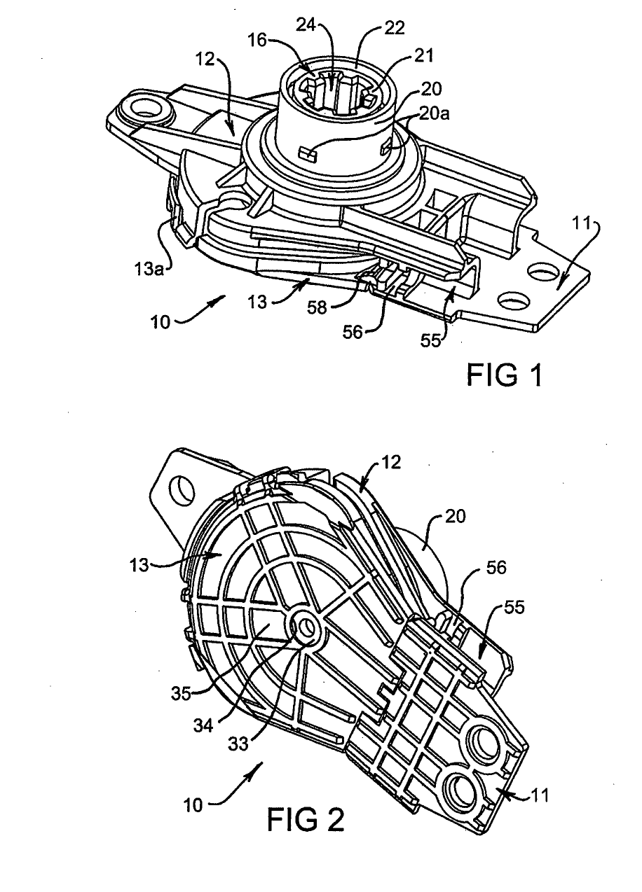

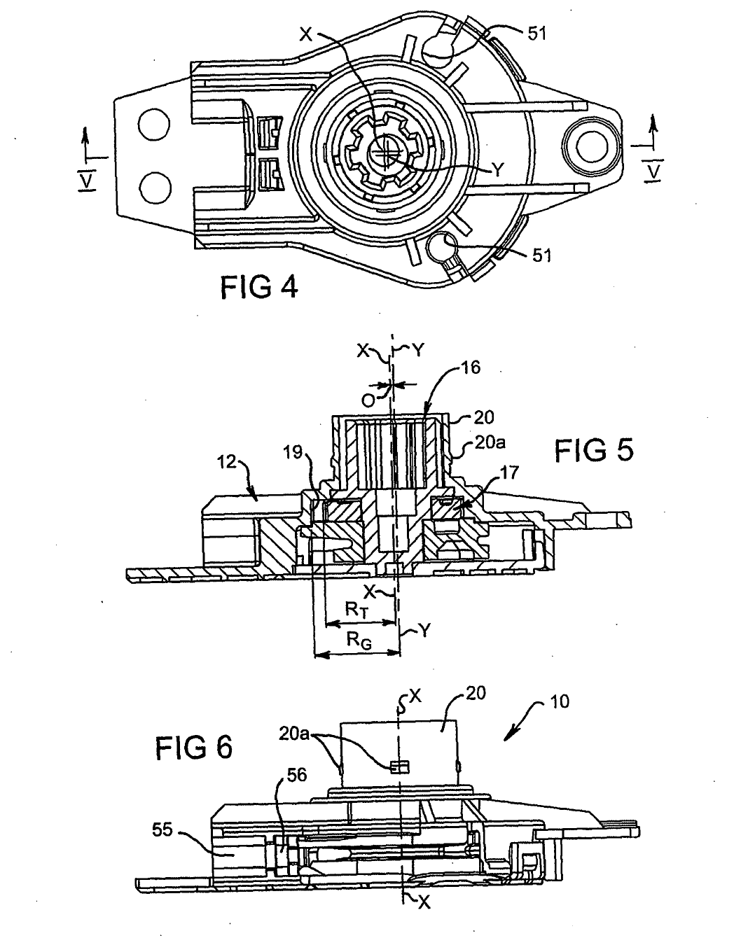

The following description describes the illustrated FIGS. 1 to 12 of an actuator 10 which is described with reference to the orientation shown in FIG. 1. It is to be understood that terms such as “upper”, “lower”, “above”, “vertical” and “horizontal” are to be construed in light of that orientation, but that the terms do not preclude use of actuator 10 in other orientations for which other relative terms are appropriate.

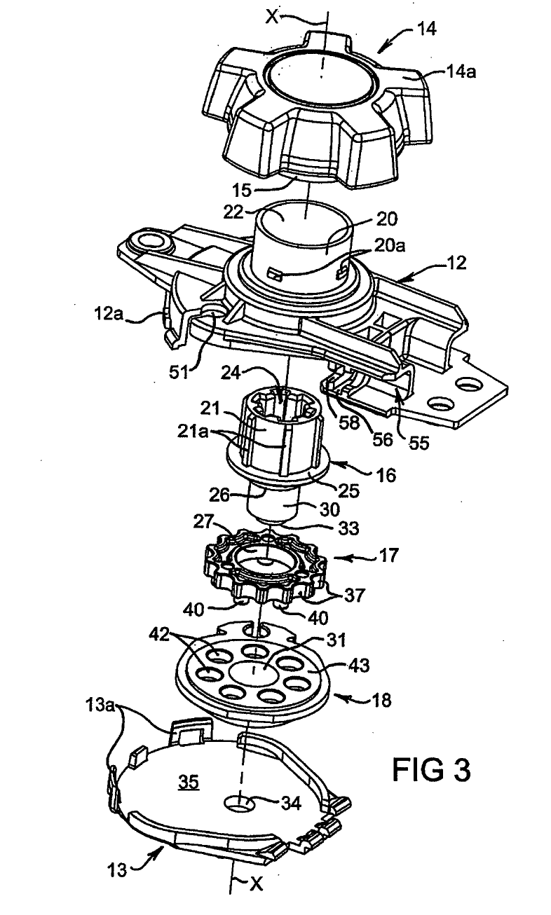

FIGS. 1 and 2 show actuator 10 assembled, while FIG. 3 shows an exploded view of the actuator 10. The actuator 10 has a housing 11 which includes an upper housing part 12 and a lower housing part 13. The upper 12 and lower 13 housing parts connect together by snap lock location of tabs 12a of the upper housing part 12 into receiving tabs 13a of lower housing part 13.

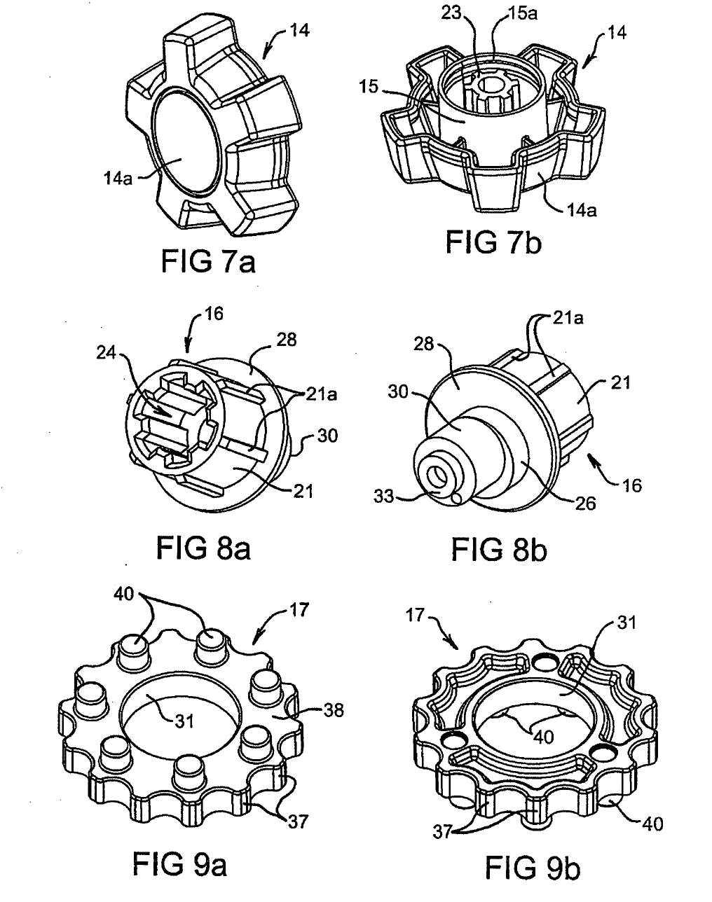

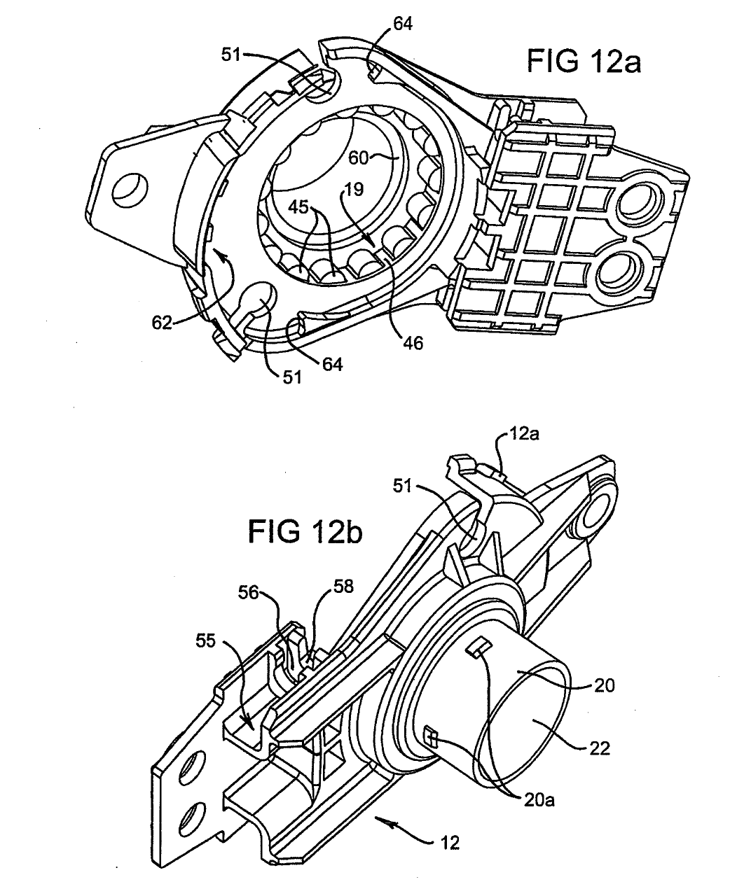

The actuator 10 includes a manually rotatable handle or knob 14, and within housing 11, a rotatable input member in the form of a multi-section shaft 16, an externally toothed gear 17 and a pulley member 18. The upper housing part 12 integrally incorporates an annular internally toothed track 19, best shown in FIG. 12(a). Upper and lower perspective views of each of the knob 14, rotatable shaft 16, the gear 17, the pulley member 18, the upper housing part 12, and the lower housing part 13 are illustrated in FIGS. 7 to 12, respectively.

From FIG. 1, it can be observed that the upper housing part 12 includes an upstanding annular skirt 20. A hollow, upper cylindrical part 21 of the rotatable shaft 16 is accommodated in skirt 20. The part 21 of the shaft 16 is spaced from the internal surface 22 of the skirt 20 to allow the shaft 16 to rotate.

However, the part 21 of shaft 16 has longitudinal ribs 21a on its external surface which slide against or are closely adjacent to surface 22 of skirt 20 to centralise part 21 in skirt 20. Also, part 21 is internally splined within its bore 24.

As shown in FIG. 7, the knob 14 consists of a generally star shaped hand grip portion 14a from which extends an annular skirt 15 (FIG. 7(b)). Within skirt 15, knob 14 includes an externally splined hub 23 which extends from portion 14a. As shown in FIG. 3, hub 23 can be inserted into the cooperatively configured splined bore 24 of part 21 of shaft 16 to enable shaft 16 to be rotated by rotation of knob 14. With hub 23 received in bore 24, skirt 15 is received concentrically over skirt 20. The knob is secured by a bead 15a around the inner surface of skirt 15 being a snap fit over projections 20a on the outer surface of skirt 20. As best shown in FIG. 5, the knob 14 and upper part 21 of the shaft 16 are centred and rotatable about a first axis X-X. Thus, manual rotation of knob 14 rotates shaft 16 about the axis X-X.

As shown in FIGS. 3 and 8, the shaft 16 has a stepped structure. Shaft 16 has a flange 25 which projects radially outwardly around the lower end of part 21. The flange 25 is able to be positioned in a corresponding shaped circular seat 60 (FIG. 12(a)) in the interior of the upper housing part 12. Spaced from part 21 by flange 25, shaft 16 has an eccentric 26 defined by a cylindrical portion centred about a second axis Y-Y, which is laterally offset from the X-X axis, such by about 1 to 2 mm. The eccentric 26 is of a size enabling it to be neatly received into a circular bore 27 of the gear 17. During assembly of the actuator 10, the gear 17 is inserted until the upper surface 29 of the gear 17 abuts the lower surface 28 of circumferential ledge 25. The gear 17 can therefore rotate about the eccentric 26 which is centred on the Y-Y axis.

Extending longitudinally from the face of eccentric 26, remote from surface 28, the shaft 16 has a cylindrical part 30. The part 30 is centred on the X-X axis and is of a size enabling it to be neatly received into a circular bore 31 of the pulley member 18. When so received, pulley member 18 can be rotated on axis X-X.

Extending longitudinally from part 30, shaft 16 has an end part 33. As shown in FIG. 5, this part 33 extends co-axially along axis X-X with part 30 and part 33 is of a size enabling it to be neatly received into a cooperating guide hole 34 formed in a base portion 35 of the lower housing part 13. The insertion of part 33 into guide hole 34 holds the rotatable shaft 16 in alignment with axis X-X and thereby substantially perpendicular to the base 35. When the actuator 10 is assembled, the shaft 16 extends through each of the gear 17 and pulley member 18, with gear 17 and pulley member 18 axially nested and in abutting engagement.

As shown in FIGS. 3 and 9, gear 17 is of flat, annular form, and has a uniform array of teeth 37 spaced about its outer circumference. Also, gear 17 has an array of projections 40 on its lower surface 38. The projections 40 are uniformly spaced around gear 17, between the teeth 37 and the bore 27, and extend parallel to axis X-X. The projections are of a form and size enabling them to be loosely received into corresponding recesses 42 formed in the pulley member 18, around bore 31. When the actuator 10 is assembled, as shown in FIG. 5, the upper surface 43 of the pulley member 18 abuts the lower surface 38 of the gear 17, with each projection 40 being received within a respective recess 42 of the pulley member 18. Thus, the pulley member 18 is axially coupled with the gear 17.

As shown in FIGS. 5 and 12(a), when the actuator 10 is assembled, the gear 17 is seated within internally toothed track 19 in the upper housing part 12. The track 19 is co-axial with the skirt 20 of housing part 12 and, hence, centered on the X-X axis. Referring to FIG. 5, it can be seen that the radius RT of the track 19 is equal to the sum of the outer radius RG of the gear 17 and the radial offset 0 between the X-X and Y-Y axes. This results in the track 19 defining a comfortably larger diameter than the diameter of the gear 17.

From FIG. 12(a) it can be seen that the track 19 has circumferentially spaced teeth 45 around its perimeter 46. The teeth 45 are configured to mesh with the teeth 37 of the gear 17. The arrangement is such that gear 17 can be driven around track 19 by orbiting relative to the X-X axis.

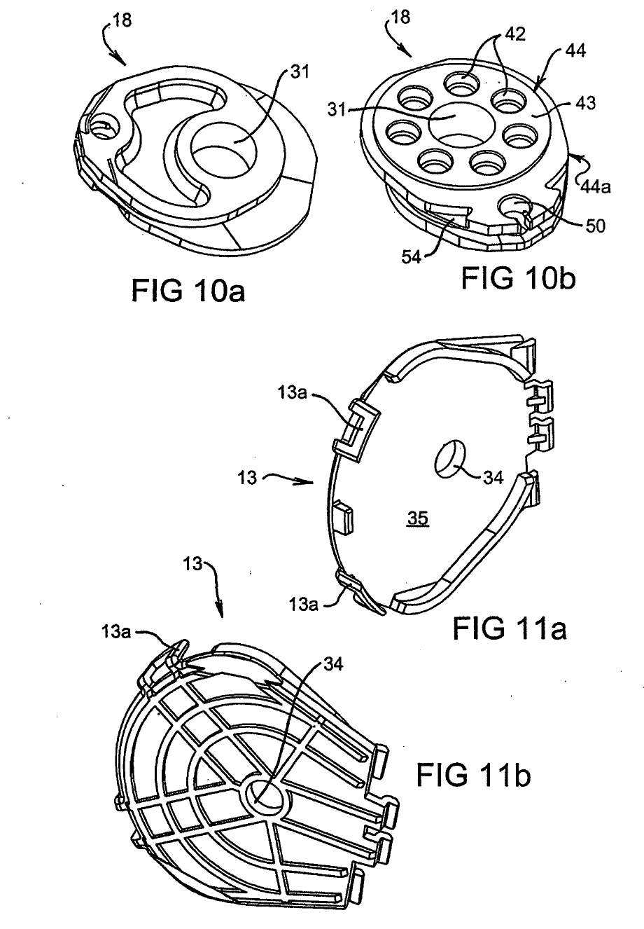

FIGS. 3 and 10 show that the pulley member 18 has two axially offset sections. A upper coupling section 44 of member 18 (best seen in FIG. 10(b)) has the form of a generally circular shaped plate and includes the circumferentially spaced recesses 42 and bore 31. A lower coupling section 44a (best illustrated in FIG. 10(a)) has the form of a generally ovoid shaped plate. The upper section 44 is used to axially couple the pulley member 18 to the gear 17. For this, each of the recesses 42 axially receives a respective one of the projections 40 of the gear 17. As can be seen in FIG. 5, recesses 42 are significantly wider than the projections 40. This difference is such as to allow orbital movement of the gear 17 about the X-X axis as a consequence of gear 17 being carried on eccentric 26 of shaft 16. During operation of the actuator 10 the gear 17 is able to orbit around the toothed track 19 about the X-X axis in a first direction, causing the gear 17 to rotate about the Y-Y axis in the opposite direction. Due to the axial offset between the first axes, gear 17 orbits relative to the pulley member 18 when the gear 17 is driven about the axis X-X.

The ovoid shape of lower section 44a of pulley member 18 is such that section 44a extends laterally beyond one side of the upper coupling section 44. The section 44a has a slotted key-hole opening 50 on its outer circumference at a location beyond that one side, with opening 50 able to receive a cylindrical barrel affixed to the end of an actuating wire of a Bowden cable. The lower section 44a further defines a cable groove 54 which extends either side of the opening 50, to enable the wire to extend in a selected direction. To enable a Bowden cable wire to be secured to section 44a, pulley member 18 is rotated to align opening with a selected one of key-hole openings 51 in the upper housing part 12. From the selected opening 51, the Bowden cable is drawn circumferentially to locate its wire in the respective groove 54, and the sheath of the Bowden cable then is secured in a slotted receiving recess 55 configured to tightly receive and hold the cable sheath of the Bowden cable. A flanged portion at the end of the cable sheath is provided for insertion within the slot 56 of the slotted recess 55. The upper housing 12 also includes an opening 58 proximate to the slotted recess 55, through which the wire of the Bowden cable can be advanced or retracted when connected to the pulley member 18 and the actuator 10 is in operation.

When the actuator 10 is assembled, the pulley member 18 is seated in a guide recess area 62 (FIG. 12(a)) formed in the interior surface of the upper housing part 12. The recess guide 62 includes two oppositely spaced stop projections 64 each of which engage a side of the pulley member 18 when the pulley member is at respective extreme positions of its movement about the X-X axis. In the illustrated embodiment, the driven member is able to move approximately 120°.

For assembly of actuator 10, the part 21 of the shaft 16 is inserted into skirt 20 until the flange 25 locates within seat 60 of the upper housing part 12. The gear 17 then is received onto eccentric 26 of shaft 16, against flange 25, and thereby located in track 19 with the teeth 37 of gear 17 meshing with the teeth 45 of track 19. The pulley member 18 is then received onto part 30 of shaft 16 and into abutting engagement with gear 17, with each of the recesses 42 receiving a respective one of the projections 40 to rotationally couple the gear 17 and pulley member 18 together. When so received, pulley member 18 is received onto shaft 16 with part 30 of the shaft 16 within the bore 31 of the pulley member 18. The lower housing part 13 then is fitted to the upper housing part 12 using the snap connectors 12a and 13a, ensuring that end part 33 of shaft 16 locates in guide hole 34 of the lower housing part 13. The knob 14 then is fitted, with its skirt 15 received concentrically over skirt 20 of upper housing part 12, until bead 15a of skirt 15 is forced over and beyond projections 20a of skirt 20. For this fitting of knob 14, its hub 23 is received into the bore 24 of part 21 of shaft 16, to interfit the splines of hub 23 and bore 24 and rotationally couple knob 14 and shaft 16.

When it is required to secure a Bowden cable to the actuator 10, it is first appropriate to determine to which of the opposite sides of the actuator 10 the Bowden cable is to extend. Assuming the pulley member 18 is to be rotated clockwise, as viewed from above in FIG. 3, in order to tension the wire of a Bowden cable, the cable of course extends anti-clockwise from its connection to the member 18. To make that connection the pulley member is rotated anti-clockwise towards one of its limiting positions by rotating knob 14 and shaft 16 clockwise. The anti-clockwise rotation of pulley member 18 is continued so as to bring the opening 50 of member 18 into register with the one of key-hole openings 51 in upper housing part 12 (the nearer opening 51 in FIG. 3). A retaining cylinder, ball or slug at the end of the wire of a Bowden cable then is able to be inserted through the round part of keyhole opening 51, into the corresponding part of opening 50 for which it is sized to be a neat fit. The wire of the cable then is dropped through the stem portion of opening 51 so as to project laterally from the stem portion of opening 50. The Bowden cable then is drawn to extend longitudinally in an anti-clockwise direction away from opening 50, so that its wire is able to pass laterally through slot 53 defined between parts 12 and 13 of housing 11. With the Bowden cable drawn anti-clockwise away from the opening 50, its wire is able to locate in the groove 54 of member 18, and the sheath of the Bowden cable is able to be secured in slotted recess 55. The pulley member 18 then is able to be rotated clockwise by anti-clockwise rotation of knob 14 and shaft 16, to advance the wire out from the sheath, after which anti-clockwise rotation of member 18 causes retraction of the cable back into the sheath. Rotation of the pulley member 18 either advances or retracts the wire of a Bowden cable lengthwise relative to the sheath of the cable, depending on the direction of rotation of member 18 by knob 14 and shaft 16.

It will be appreciated that the actuator 10 is able to receive a Bowden cable from either of two directions, avoiding the need for the actuator 10 to be produced in right hand and left hand versions. Thus, the upper housing part 12 has a slotted receiving recess 55 and opening 58 symmetrically disposed on both left and right hand sides of the housing 12, and the Bowden cable is able to be connected to the actuator 10 via either of these receiving recesses 55 and openings 58.

In operation, a user rotates the knob 14 in a selected direction to adjust the position of a seat lumbar support apparatus (not illustrated) connected to the Bowden cable. Rotation of the knob 14 in either direction directly rotates the shaft 16 about the X-X axis in the same direction. As eccentric 26 is part of shaft 16, and as eccentric 26 is centred about the Y-Y axis, the Y-Y axis is caused to orbit around the X-X axis in the direction of rotation as shaft 16. With orbiting of the Y-Y axis, gear 17 orbits similarly. However, as teeth 37 of gear 17 are meshed with teeth 45 of track 19, gear 17 is caused to rotate on the Y-Y axis, but with the direction of rotation of gear 17 being in the opposite direction to that in which gear 17 orbits and shaft 16 rotates. As gear 17 is coupled to the pulley member 18 by the location of projections 40 in recesses 42, the pulley is drawn by gear 17 to rotate on the X-X axis, in the direction of rotation of gear 17 and opposite to the direction of rotation of shaft 16. As pulley member 18 is rotatable on the X-X axis, the loose fitting of projections 40 in recesses 42 needs to be sufficient to allow for the orbital movement of gear 17. Rotation of pulley member 18 rotates its opening 50 and advances or retracts (ie pulls or pushes) the wire of a Bowden cable which is operatively connected as described above.

Assuming the other end of a Bowden cable is connected to a lumbar support, movement of the wire of the cable adjusts the position of the lumbar support. Once a desired adjustment has been made to the lumbar support of a seat, the actuator 10 is able to resist a backdriving load applied through the Bowden cable wire 52. A backdriving load may occur simply because of pressure applied by a person sitting in the seat. The tendency under a backdriving load is for the pulley member 18 to rotate and cause the cable wire 52 to shift from its position after the desired adjustment and enable the lumbar support to be adjusted unintentionally. However, the actuator 10 generally prevents rotation of the driven member 18 under a backdriving load up to a limit beyond loads encountered in normal use of a lumbar support.

Referring to FIG. 3, a backdriving force applied through a Bowden cable can apply a substantially tangential force to the driven member 18 at the slot 50 about the X-X axis. That force, via the coupling between the pulley member 18 and gear 17 applies a rotational force to the gear 17 about the Y-Y axis. This cannot actuate rotation of the gear 17 about the X-X axis because movement of gear 17 about the Y-Y axis is restrained by the meshing engagement of the teeth 37 of the gear 17 with teeth 45 of the track 19. The gear 17 can only move about the X-X axis when the shaft 16 rotates to cause the Y-Y axis to orbit about the X-X axis. Consequently, a backdriving force able to move the gear 17 about the Y-Y axis, would need to be very substantial and would be well in excess of forces normally encountered.

Actuator 10 provides a geared reduction between the gear 17 and the pulley member 18, so that the input load is multiplied through the pulley member 18. The gear ratio is the ratio of the offset between the X-X and Y-Y axes and the radius of gear 17. The gearing is provided by the eccentric arrangement between the part 26 of shaft 16 and the pulley member 18, and can be arranged so that only about five turns of the shaft 16 enable full rotational travel of the pulley member 18. This compares favourable with other actuators.

A gear ratio of between 10:1 to 18:1 between the shaft 16 and the gear 17 assists in enabling about 5 turns of the shaft 16 to achieve rotational travel of the pulley member 18 sufficient to provide a required range of relative longitudinal movement between the wire and sheath of a Bowden cable. The form of the pulley member 18 assists with this since, as shown in FIG. 3, the slotted opening 50 on the lower section 44a of the pulley member 18 is spaced from the axis of the bore 31 by an amount greater than the radius of gear 17 to provide a required level of longitudinal movement between the wire and the sleeve of the Bowden cable, for a given rotation of the pulley member 18. The opening 50 may be spaced from the axis of bore 31 by from about 1.8 to 2.2 times, preferably about 2 times, the radius of gear 17.

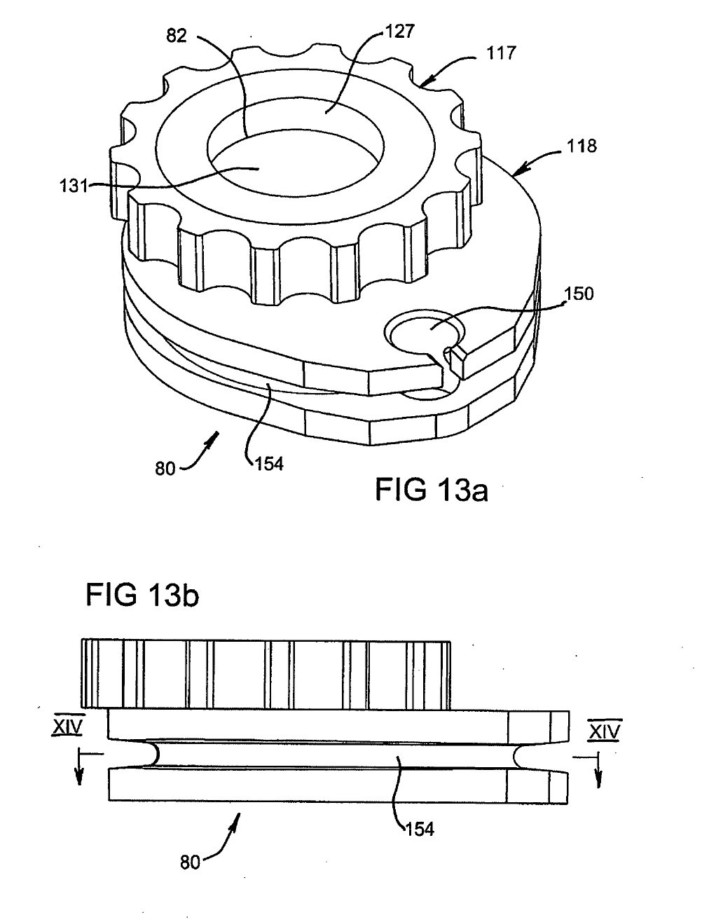

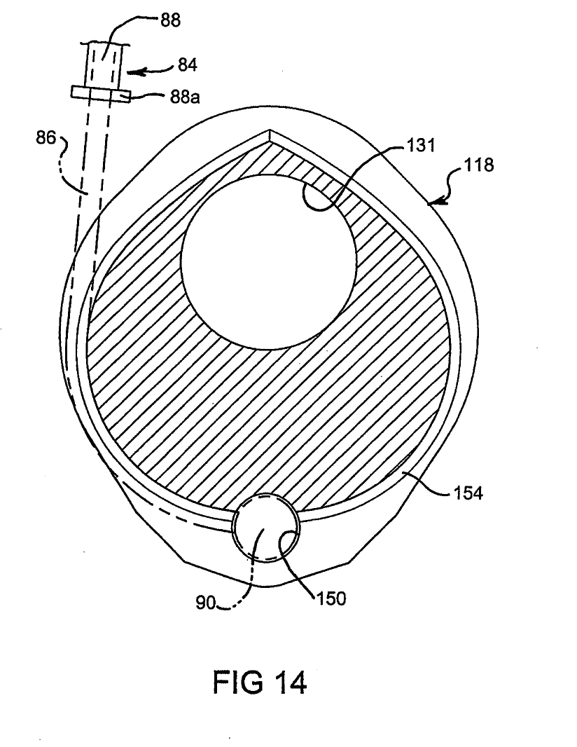

FIGS. 13(a) and 13(b) show a member 80 which, in an actuator otherwise corresponding to actuator 10 of FIGS. 1 to 6, replaces the gear 17 and pulley member 18 of actuator 10. The member 80 has an upper gear portion 117 and a lower pulley portion 118. Features of portions 117 and 118 of member 80 which correspond to features of gear 17 and pulley member 18 have the same reference numeral, plus 100. Also, the following description principally is limited to matters of difference between member 80 and the corresponding arrangement in actuator 10 of FIGS. 1 to 6.

One important difference is that member 80 is in one piece. That is, portions 117 and 118 are not unintentionally separable and, while they may be releasably secured together by screws or the like, they preferably are formed integrally, or made integral such as by bonding. Thus, portion 117 is not able to orbit around an axis relative to portion 118. Also, while a line 82 is shown as separating the bore 127 in gear portion 117 and bore 131 in pulley portion 118, those bores are co-axial and preferably are of the same diameter, in which case line 82 simply separates respective portions of the one bore through member 80.

The member 80 necessitates a modified form of shaft since portions 117 and 118 must be on a common axis and orbiting of gear portion 117 will necessitate member 80 orbiting as a whole. Thus, relative to shaft 16 for actuator 10 of FIGS. 1 to 6, part 30 of shaft 16 would need to be co-axial with eccentric 26 or of a modified form which did not impede rotation of member 80 on eccentric 26, and which also simply carried part 33 of shaft 16. Preferably part 30 would be co-axial with eccentric 26 and of the same radius as eccentric 26.

In use of member 80, with a suitable modified shaft, operation is similar to operation with actuator 10 of FIGS. 1 to 6. A Bowden cable is able to be connected in the same way. Also, the wire of the cable is able to be advanced or retracted by rotating the knob to rotate the shaft in the same direction, and to achieve rotation of the connection between the Bowden cable wire and member 80 in the opposite direction. What is different is that, relative to the X-X and Y-Y axes of FIGS. 1 to 6, the gear portion 117 and the pulley portion 118 move in unison, given that they are parts of the one component comprising member 80. Thus, portions 117 and 118 together orbit around the X-X axis in one direction while rotating on the Y-Y axis in the opposite direction, due to the teeth 137 of gear portion 117 remaining meshed with the internal teeth of a gear track defined by the actuator housing and corresponding to teeth 45 of track 19 of actuator 10 of FIGS. 1 to 6.

With actuator 10 of FIGS. 1 to 6, the interior of the housing 11 needs to allow for rotation of pulley member on the X-X axis. In the case of an actuator, having member 80 needs to allow for rotation of pulley portion 118 on the Y-Y axis, simultaneously with orbiting of portion 118 around the X-X axis. However, as indicated above, the offset between these axes is small, and likely to be less than about 2 mm, such as about 1.2 mm.

FIG. 14 shows member 80 on the sectional line XIV-XIV of FIG. 13. However, in addition to showing further detail of member 80, FIG. 14 also shows an end portion of a Bowden cable 84. The cable 84 has a wire 86 movable longitudinally relative to a sheath 88. For this, a cylinder, slug or ball 90 secured at one end of the wire 86 is located in opening 150 of member 80. From opening 150, the wire 86 extends around a groove 154 extending around the periphery of member 80 to a location at which sheath 88 is secured by its terminal flange 88a against movement relative to a housing in which member 80 is used

Those skilled in the art will appreciate that the invention described herein is susceptible to variations and modifications other than those specifically described. It is understood that the invention includes all such variations and modifications which fall within the spirit and scope.

We claim:

1. An actuator, suitable for use in adjusting a device by means of a Bowden cable, wherein the actuator includes:
(a) a housing;
(b) an input shaft mounted in the housing and rotatable on a first axis, the shaft having an eccentric portion centered on a second axis laterally offset from the first axis;
(c) a gear track defined by, or fixed in relation to, the housing and concentric with the first axis;
(d) a gear member rotatable on the eccentric portion of the input shaft and drivingly engaged with teeth of the gear track defined by, or fixed in relation to, the housing; and
(e) a pulley member rotatably mounted on the input shaft and rotatable with rotation of the gear member the pulley being adapted for securing an end of a wire of a Bowden cable;
wherein, with rotation of the input shaft on the first axis, the gear member is caused by the eccentric to orbit around the first axis while being caused by its engagement with the gear track to rotate on the second axis and thereby rotate the pulley member for longitudinally advancing or retracting the wire of the Bowden cable relative to the sheath of a Bowden cable.

2. The actuator of claim 1, wherein the gear member and the pulley member inter-fit in a manner enabling the pulley member to rotate on the first axis in response to rotation of the gear member on the second axis, while enabling the gear member to orbit with respect to the first axis relative to the pulley member.

3. The actuator of claim 2, wherein the gear member and the pulley member inter-fit by projections on one of them locating in recesses in the other of them, with the recesses being larger than the projections thereby to allow orbiting of the gear member relative to the pulley member.

4. The actuator of claim 1, wherein the gear member and the pulley member move in unison so that they each rotate on the second axis while orbiting with respect to the first axis.

5. The actuator of claim 4, wherein the pulley member and the gear member are secured together so as to be movable in unison.

6. The actuator of claim 4, wherein the pulley member and the gear member are parts of an integral component.

7. The actuator of claim 6, wherein the component is integrally formed.

8. The actuator of claim 1, wherein the gear track is formed integrally with a section of the housing.

9. The actuator of claim 1, wherein the gear member is an externally toothed gear, the gear track is an internally toothed gear track formed integrally with a section of the housing, and the teeth of the gear and gear track are in direct meshed engagement.

10. The actuator of claim 1, wherein the pulley member is of ovoid shape to define a first part adjacent to which the gear member is located and a second part which extends laterally beyond the gear member, and wherein the pulley member is adapted for securing an end of the wire of the Bowden cable at a location on the second part of the pulley member spaced from the first and second axes by more than, such about twice, the radius of the gear member.

11. The actuator of claim 10, wherein the pulley member defines a circumferential groove which extends from said location and in which the wire can be wound or unwound, depending on the direction of rotation of the pulley member.

12. The actuator of claim 1, wherein the input shaft has a first end portion to which a knob or handle for rotating the shaft member can be fitted, a section adjacent to the first end portion which defines the eccentric portion and between the eccentric portion and a second end portion, a portion on which the pulley member is located.

13. The actuator of claim 12, wherein the gear member and the pulley member move in unison so that they each rotate on the second axis while orbiting with respect to the first axis, and wherein the portion of the input shaft on which the pulley member is located is an eccentric continuation of the eccentric portion.

14. The actuator of claim 12, wherein the housing has two releasably connected housing parts, one of the housing parts defining a skirt in which the first end portion of the input shaft is received, and the other housing part defining a recess in which the second end portion of the input shaft is rotatable.

15. The actuator of claim 14, wherein the input shaft has a peripheral flange between the first end portion and the eccentric portion, and the one housing part defines a seat in which the flange is located.
